(19) United States
(12) Patent Application Publication
(10) Pub. No.: US 2015/0278960 A1
(43) Pub. Date: Oct. 1, 2015

(54) Identifying and Suggesting Companies With Employment Opportunities Within a Social Network

(71) Applicants: Matthew Aaron Moore, San Francisco, CA (US); Sunil Chandra, San Francisco, CA (US)

(72) Inventors: Matthew Aaron Moore, San Francisco, CA (US); Sunil Chandra, San Francisco, CA (US)

(73) Assignee: GOOGLE INC., Mountain View, CA (US)

(21) Appl. No.: 13/547,002

(22) Filed: Jul. 11, 2012

Related U.S. Application Data
(60) Provisional application No. 61/652,024, filed on May 25, 2012.

(51) Int. Cl. G06Q 50/00; G06F 3/0482; H04L 29/08

(52) U.S. Cl. CPC G06Q 50/01; H04L 67/22; G06F 3/0482

(57) ABSTRACT

The present disclosure describes systems and methods for identifying and suggesting entities with employment opportunities within social networks. The systems and methods are configured to identify and suggest companies to users who are connected in a social graph, by retrieving user connection data including a list of users who are connected, and subsequently, retrieving each of the users' employment information. A particular user may search for a job opportunity from among the list of relevant entities compiled from the employment information. Search results are provided for display, via a user interface, which accepts user selection of one or more particular entities in the search results, and provides one or more links to trigger a search for an employment opportunity with the particular entities serving as a filter. The particular user may view a display of other users who have been employed by the particular entities that serve as a filter.

### BACKGROUND

This application claims priority under 35 U.S.C. §119(e) to U.S. Application No. 61/652,024, entitled “Identifying and Suggesting Companies with Employment Opportunities Within a Social Network” filed May 25, 2012, the entirety of which is herein incorporated by reference.

The present disclosure relates to identifying and suggesting employment opportunities via an online community, for example, a social network. In particular, the present disclosure relates to identifying and suggesting employment opportunities based on a social graph.

In the last decade, searching for employment, via online communities, has become increasingly popular. Entities (for example, companies) advertise employment opportunities over the internet, via websites that are dedicated to this purpose or otherwise.

Many people prefer to search for employment, through their connections including their friends and family. Existing technologies do not provide a way to either advertise or search for employment opportunities, in an online community, based on a user's social graph and/or employment information.

With the ongoing trends and exponential growth in online searches for employment, it would certainly be beneficial to find better ways to conduct online searching for employment, within a social network, by using user social graphs.

### SUMMARY

In some embodiments, this technology comprises systems and methods for identifying and suggesting entities with employment opportunities, via social networks. Specifically, this technology comprises systems and methods for identifying and suggesting companies to users who are connected in a social graph. For example, the systems and methods first retrieve user connection data (e.g., circles) in a social network (e.g., Google Pius), and subsequently retrieve a list of users who share connections or affinity (e.g., users in particular circles). This technology then retrieves each of the users' employment information. In this way, a particular user may search for a job opportunity from among the list of entities retrieved from the social graph data. A user interface presents the search results on the entities found, accepts selection by the user of a particular entity in the search results, and provides a link (e.g., via an online service) to trigger a search for an employment opportunity with the particular entity serving as a filter. The particular user may see a display of other users who have been employed by the particular entity that serves as a filter.

In yet other embodiments, the systems and methods of this technology selectively suggest entities to a particular user, based at least in part, on the particular user's social profile information (e.g., work history, education, location, hobbies, etc.). For example, in some embodiments, the systems and methods may determine that a particular user has attended a university to study computer programming. The systems and methods identify a list of companies within the social graph that require computer programmers and recommend companies that hire computer programmers.

### BRIEF DESCRIPTION OF THE DRAWINGS

The present disclosure is illustrated by way of example, and not by way of limitation, in the figures of the accompanying drawings, in which like reference numerals are used to refer to similar elements.

FIG. 1 is a high-level block diagram illustrating some embodiments of a system for identifying and suggesting entities (e.g., companies) with a company suggestion module.

FIG. 2 is a block diagram illustrating some embodiments of a social network server shown in FIG. 1, including its hardware components.

FIG. 3 is a block diagram illustrating some embodiments of the company suggestion module and its software components.

FIG. 4 is a flow chart illustrating an example general method for identifying and suggesting companies.

FIG. 5 is a flow chart illustrating example operations for retrieving user data.

FIG. 6 is a flow chart illustrating example operations for displaying user data.

FIG. 7 is a graphical representation of one example of displaying a list of companies that employ people in a user's groups.

FIG. 8 is a graphical representation of one example of displaying a company with employees that are in a user's groups.

FIG. 9 is a graphical representation of one example of displaying a list of suggested companies.

### DETAILED DESCRIPTION

In some embodiments, this technology comprises systems and methods for identifying and suggesting entities (e.g., companies, partnerships, individuals, conglomerates, organizations, etc.) with employment opportunities, via social networks. Reference to a “company” in this specification and the drawings represents any entity or organization that is seeking employees or candidates for employment.

Specifically, this technology comprises systems and methods for identifying and suggesting companies to users who are connected in a social graph. For example, the systems and methods first retrieve user connection data (e.g., circles) in a social network (e.g., Google Plus), and subsequently retrieve a list of users who share the user connections (e.g., users in particular circles). The technology then retrieves each of the users' employment information. In this way, a particular user may search for a job opportunity from among the list of entities retrieved from the social graph data. A user interface presents the search results on the entities found, accepts selection by the user of a particular entity in the search results, and provides a link (e.g., via an online service) to trigger a search for an employment opportunity with the particular entity serving as a filter. The particular user may see a display of other users who have been employed by the particular entity that serves as a filter.

In yet other embodiments, the systems and methods selectively suggest entities to a particular user, based at least in part, on the particular user's social profile information (e.g., work history, education, location, hobbies, etc.). For example, in some embodiments, the systems and methods may determine that a particular user has attended a university to study computer programming. The systems and methods identify a list of companies within the social graph that require computer programmers and recommend companies that hire computer programmers.

In some examples, the specification describes systems and methods for identifying and suggesting job opportunities based on connections in a social network, by identifying employment opportunities based on a social graph. In the following description, for purposes of explanation, numerous specific details are indicated in order to provide a thorough understanding of the technology described. It should be apparent, however, to one skilled in the art, that this technology can be practiced without these specific details. In other instances, structures and devices are shown in block diagram form in order to avoid obscuring the technology. For example, the present technology is described with some embodiments below with reference to user interfaces and particular hardware. However, the present technology applies to any type of computing device that can receive data and commands, and any devices providing services. Moreover, the present technology is described below primarily in the context of providing support for identifying and suggesting job opportunities based on connections in a social network; however, those skilled in the art should understand that the present technology applies to any type of connection and can be used for other applications beyond social networks. In particular, this technology for identifying and suggesting connections may be used in other contexts besides social networks.

Reference in the specification to “one embodiment,” “an embodiment,” or “some embodiments” means simply that one or more particular features, structures, or characteristics described in connection with the one or more embodiments is included in at least one or more embodiments that are described. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory of either one or more computing devices. These algorithmic descriptions and representations are the means used by those skilled in the data processing arts to most effectively convey the substance of their work to others skilled in the art. An algorithm as indicated here, and generally, is conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the following discussion, it should be appreciated that throughout the description, discussions utilizing terms such as “processing,” “computing,” “calculating,” “determining,” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present technology also relates to an apparatus for performing the operations described here. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, CD-ROMs, magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

This technology can take the form of an entirely hardware embodiment, an entirely software embodiment, or an embodiment including both hardware and software components. In some embodiments, this technology is implemented in software, which includes but is not limited to firmware, resident software, microcode, etc.

Furthermore, this technology can take the form of a computer program product accessible from a computer-usable or computer-readable medium providing program code for use by or in connection with a computer or any instruction execution system. For the purposes of this description, a computer-usable or computer-readable medium may be any apparatus that can include, store, communicate, propagate, or transport the program for use by or in connection with the instruction execution system, apparatus, or device.

A data processing system suitable for storing and/or executing program code includes at least one processor coupled directly or indirectly to memory elements through a system bus. The memory elements may include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Communication units including network adapters may also be coupled to the systems to enable them to couple to other data processing systems, remote printers, or storage devices, through either intervening private or public networks. Modems, cable modems, and Ethernet cards are just a few examples of the currently available types of network adapters.

Finally, the algorithms and displays presented in this application are not inherently related to any particular computer or other apparatus. Various general-purpose systems may be used with programs in accordance with the teachings here, or it may prove convenient to construct more specialized apparatus to perform the required method steps. The required structure for a variety of these systems is outlined in the description below. In addition, the present technology is not described with reference to any particular programming language. It should be understood that a variety of programming languages may be used to implement the technology as described here.

### System Overview

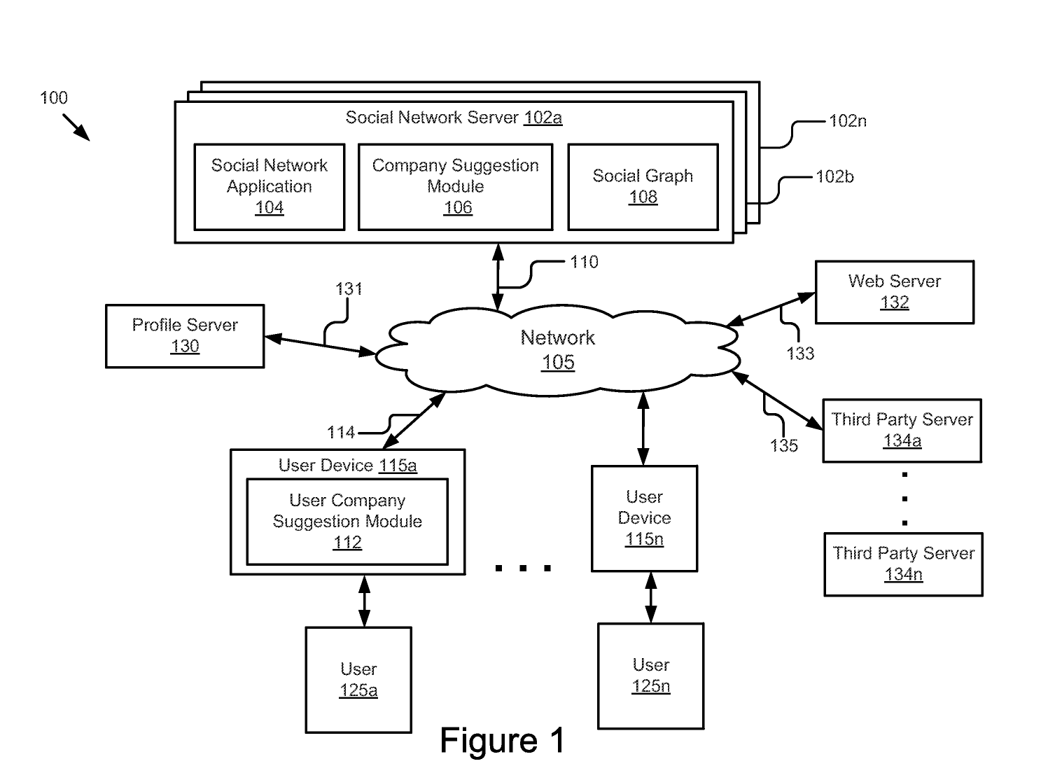

FIG. 1 is a high-level block diagram illustrating some embodiments of systems for identifying and suggesting job opportunities based on connections in a social network, by identifying employment opportunities based on a social graph. The system 100 illustrated in FIG. 1 provides a framework for identifying and suggesting employment opportunities for users of a social network. Searches for employment opportunities utilize a user's social graph, thereby focusing employment searching efforts based on user connections. The system 100 includes one or more social network servers 102a, 102b, through 102n, that may be accessed via user devices 115a through 115n, which are used by users 125a through 125n, to connect to any one of the social network servers 102a, 102b, through 102n. These entities are communicatively coupled via a network 105. Although only two user devices 115a through 115n are illustrated, persons of ordinary skill in the art should recognize that any numbers of user devices 115n may be used by any number of users 125n.

Moreover, those skilled in the art should recognize that while the present disclosure is described below primarily in the context of providing a framework for identifying and suggesting employment opportunities, the present disclosure may be applicable to other situations where establishing connections for any purpose that is not related to job opportunities, is necessary or desired. For ease of understanding and brevity, the description the present disclosure is described in reference to identifying and suggesting employment opportunities to a particular user of a social network.

The user devices 115a through 115n in FIG. 1 are illustrated by way of example. Although FIG. 1 illustrates only two devices, the present disclosure applies to any system architecture having one or more user devices 115, therefore, any number of user devices 115n may be used. Furthermore, while only one network 105 is illustrated as coupled to the user devices 115a through 115n, the social network servers, 102a-102n, the profile server 130, the web server 132, and third party servers 134a through 134n, in practice, any number of networks 105 may be connected to these entities. In addition, although only two third party servers 134 through 134n are shown, the system 100 may include any number of third party servers 134n.

In some embodiments, the social network server 102a is coupled to the network 105 via a signal line 110. The social network server 102a includes a social network application 104, which comprises the software routines and instructions to operate the social network server 102a and its functions and operations. Although only one social network server 102a is described here, persons of ordinary skill in the art should recognize that multiple servers may be present, as illustrated by social network servers 102b through 102n, each with functionality similar to social network server 102a or different.

The term “social network” as used here encompasses its plain and ordinary meaning including, but not limited to, any type of social structure where the users are connected by a common feature or link. The common feature includes relationships/connections, e.g., friendship, family, work, a similar interest, etc. The common features are provided by one or more social networking systems, such as those included in the system 100, including explicitly-defined relationships and relationships implied by social connections with other online users, where the relationships form the social graph 108.

The term “social graph” as used here encompasses its plain and ordinary meaning including, but not limited to, a set of online relationships between users, such as provided by one or more social networking systems, such as the social network system 100, including explicitly-defined relationships and relationships implied by social connections with other online users, where the relationships form a social graph 108. In some examples, the social graph 108 may reflect a mapping of these users and how they are related.

It should be understood that the social network server 102a and the social network software/application 104 are representative of a single social network. Each of the plurality of social networks 102a, 102b through 102n, is coupled to the network 105, each having its own server, application, and social graph. For example, a first social network 102a hosted on a social network server may be directed to business networking, a second 102b directed to or centered on academics, a third 102c (not shown) directed to local business, a fourth 102d (not shown) directed to dating, and yet others (102n) directed to other general interests or perhaps a specific focus.

A profile server 130 is illustrated as a stand-alone server in FIG. 1. In other embodiments of the system 100, all or part of the profile server 130 may be part of the social network server 102a. The profile server 130 is connected to the network 105 via a line 131. The profile server 130 has profiles for all the users who belong to a particular social network 102a-102n. One or more third party servers 134a through 134n are connected to the network 105, via signal line 135. A web server 132 is connected, via line 133, to the network 105.

The social network server 102a includes a company suggestion module 106, to which user devices 115a through 115n are coupled via the network 105. In particular, user device 115a is coupled, via line 114, to the network 105. The user 125a interacts with the user device 115a to initiate a search for employment, for example, to search for employment opportunities within connections of the user 125a. Persons of ordinary skill in the art should recognize that the company suggestion module 106 may be stored in the social network server 102a. In other embodiments, a user company suggestion module 112 is stored in a user device 115a, which may include one or more elements or components of the company suggestion module 106 configured to execute the functionality of the company suggestion module 106.

The user devices 115a through 115n may be a computing device, for example, a laptop computer, a desktop computer, a tablet computer, a mobile telephone, a personal digital assistant (PDA), a mobile email device, a portable game player, a portable music player, a television with one or more processors embedded in the television or coupled to it, or any other electronic device capable of accessing a network.

The network 105 is of conventional type, wired or wireless, and may have any number of configurations such as a star configuration, token ring configuration, or other configurations known to those skilled in the art. Furthermore, the network 105 may comprise a local area network (LAN), a wide area network (WAN, e.g., the Internet), and/or any other interconnected data path across which one or more devices may communicate.

In another embodiment, the network 105 may be a peer-to-peer network. The network 105 may also be coupled to or include portions of one or more telecommunications networks for sending data in a variety of different communication protocols.

In yet another embodiment, the network 105 includes Bluetooth communication networks or a cellular communications network for sending and receiving data such as via short messaging service (SMS), multimedia messaging service (MMS), hypertext transfer protocol (HTTP), direct data connection, WAP, email, etc.

In some embodiments, the social network servers, 102a-102n, the profile server 130, the web server 132, and the third party servers 134a through 134n are hardware servers including a processor, memory, and network communication capabilities. One or more of the users 125a through 125n access any of the social network servers 102a through 102n, via browsers in their user devices and via the web server 132.

By way of one example, in some embodiments of the system, information on user work experience is retrieved for particular users (125a through 125n) of a social network 102 a through 102n from the social graph 108. In addition, information on the entities, companies, or organizations that employ these particular users is also retrieved from the social graph 108. It should be noted that any information that is retrieved for particular users is only upon obtaining the necessary permissions from the users, in order to protect user privacy and any sensitive information of the users. The information on the entities, companies, or organizations, includes employment opportunities offered by them. The company suggestion module 106 conducts an employment search through the companies that are retrieved from particular users in the social graph.

By way of another example, in some embodiments, employment opportunity suggestions that are provided to a particular user are tailored to aspects of the user's information, for example, a computer employment opportunity is provided to a user with computer experience.

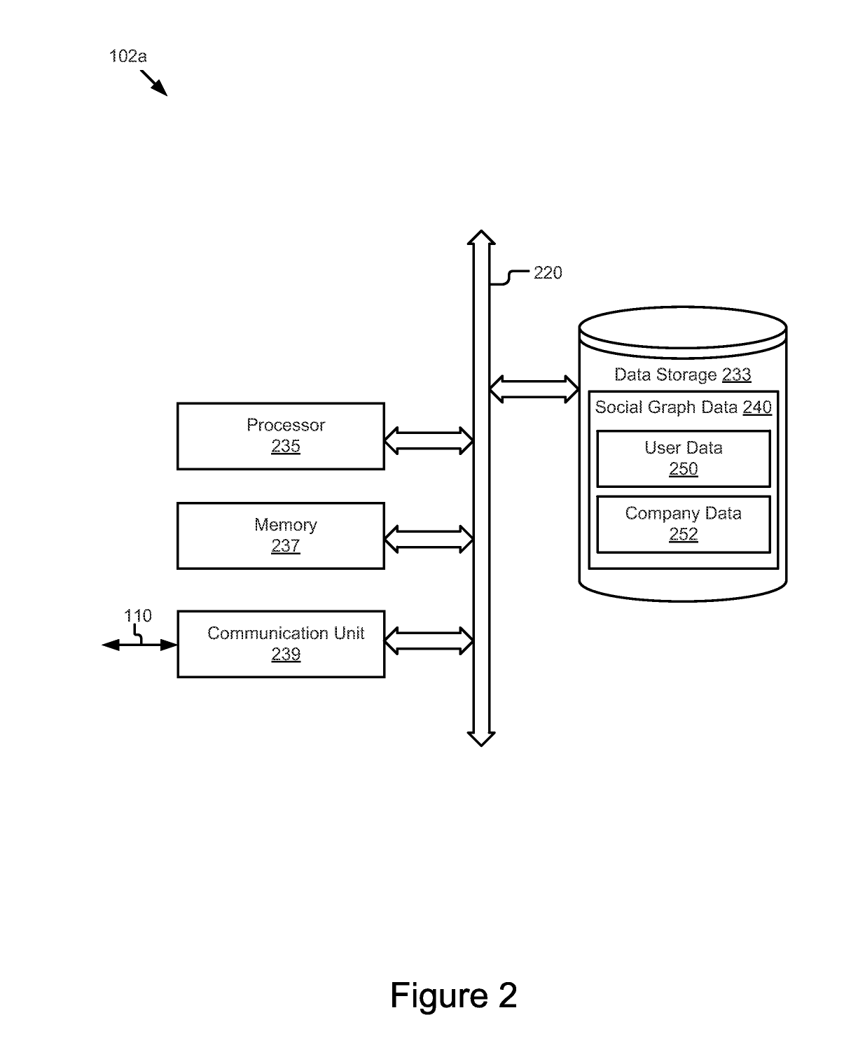

FIG. 2 is a block diagram illustrating some embodiments of the social network server 102a. In FIG. 2, like reference numerals have been used to reference like components with the same or similar functionality that has been described above with reference to FIG. 1. Since those components have been described above that description is not repeated here. The social network server 102a generally comprises one or more processors, although only one processor 235 is illustrated in FIG. 2. The processor is coupled via a bus 220 to memory 237 and data storage 233, which stores social graph data 240 for particular users (related to the social graph 108 shown FIG. 1) and any information received from any of the other sources identified above. The social graph data 240 includes user data indicated by reference numeral 250 and company data indicated by reference numeral 252. In some embodiments, the data storage 233 is a database organized by user. For each user, the data storage 233 stores data related to user information (e.g., name, age, education, professional experience, etc.) as part of user data 250 and employment opportunity information (e.g., name, years in business, category, jobs available, etc.) as part of company data 252. For example, these data types may include related social network activity such as posts, shares, invitations, status changes etc., any or all of these network activities, associated with obtaining employment by or for a particular user.

A user 125a, via a user device 115a, communicates a request for an employment search or responds to a request, via communication unit 239. The search for employment is managed by the company suggestion module 106 (FIG. 1) and/or the user company suggestion module 112 (FIG. 1) or both. The company suggestion module 106 and the user company suggestion module 112 are not shown in FIG. 2, but these modules may reside, in their entirety or parts of them, in the user's device (115a through 115n), in the social network server 102a (through 102n), or alternatively, in a separate server, for example the third party server 134 (FIG. 1). The user device 115a communicates with the social network server 102a using the communication unit 239, via signal line 110.

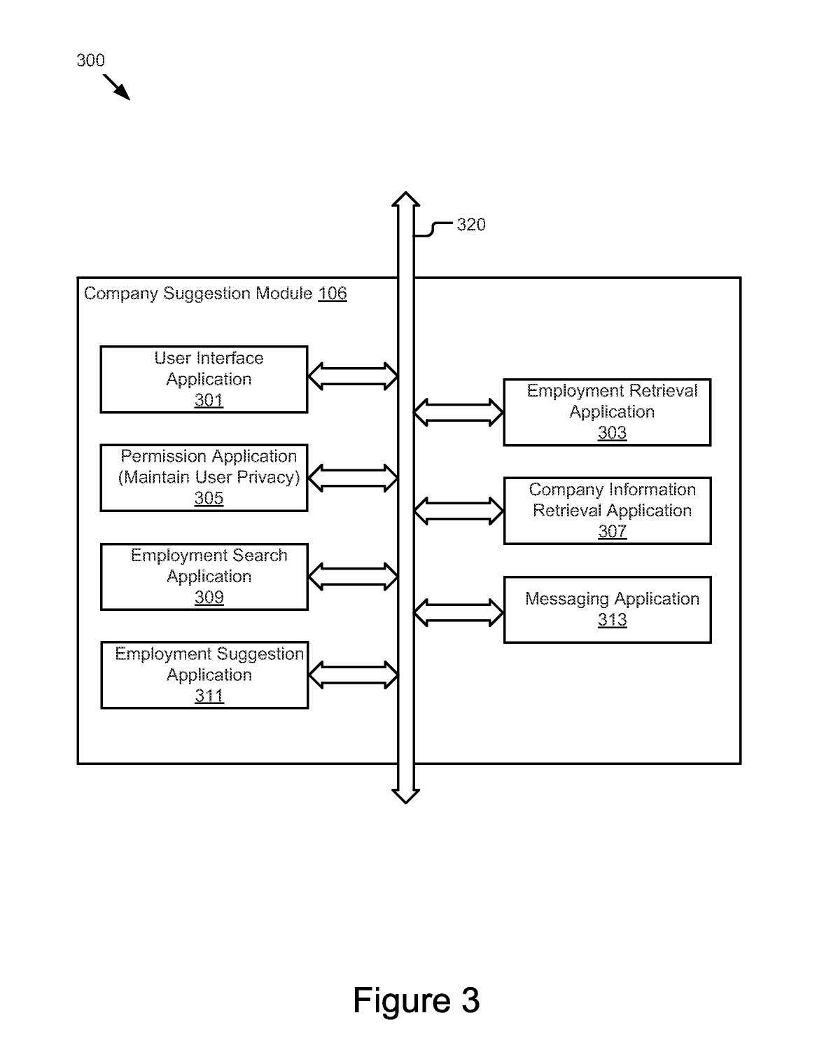

Referring now to FIG. 3, like reference numerals have been used to reference like components with the same or similar functionality that has been described above with reference to FIGS. 1 and 2. Since those components have been described above that description is not repeated here. The company suggestion module 106 includes various applications or engines that are programmed to perform the functionalities described here. A user interface application 301 is coupled to a software communication mechanism 320 to communicate with an employment retrieval application 303, and a permission application 305 for obtaining permission to view user and company information on a user interface.

The company suggestion module 106 includes applications or engines that communicate over the software communication mechanism 320. Software communication mechanism 320 may be an object bus (such as CORBA), direct socket communication (such as TCP/IP sockets) among software modules, remote procedure calls, UDP broadcasts and receipts, HTTP connections, function or procedure calls, etc. Further, any or all of the communication could be secure (SSH, HTTPS, etc). The software communication can be implemented on any underlying hardware, such as a network, the Internet, a bus 220, a combination thereof, etc.

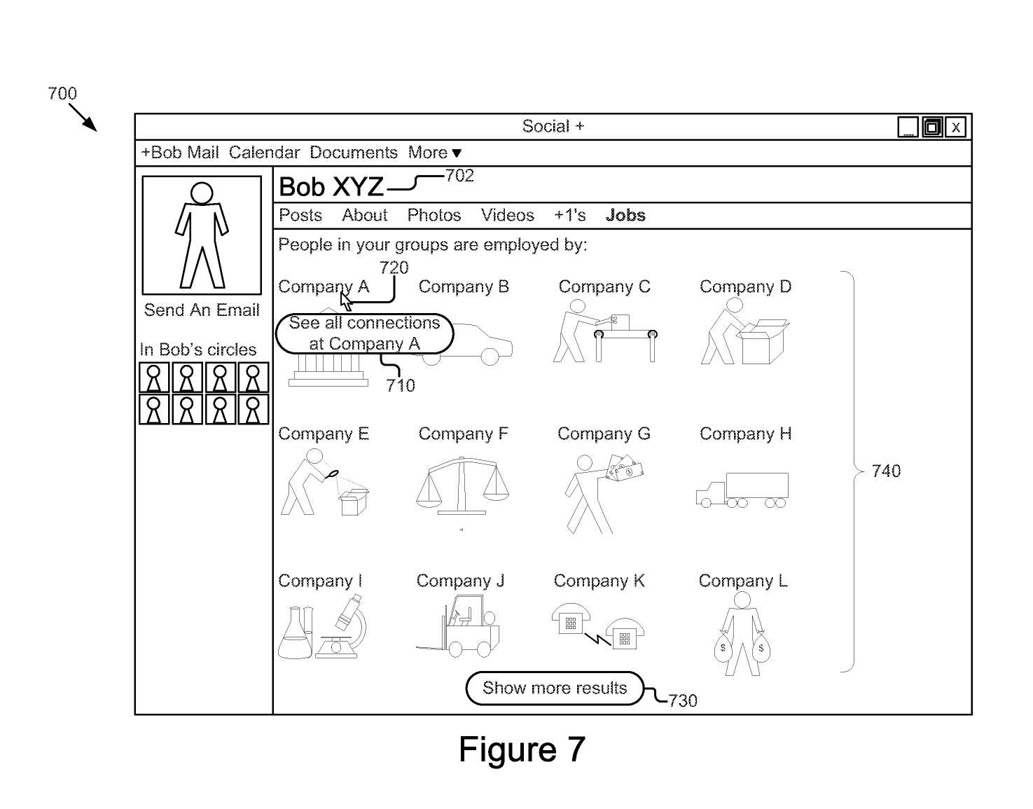

By way of example, a particular user 125a communicates via a user device 115a, to either request an employment or job search or respond to a request to obtain user information, with this information displayed on a user interface (example of a user interface shown in FIG. 7). The employment retrieval application 303 retrieves a particular user's information (after receiving permission) pertaining to employment opportunities (e.g., work history, education, etc.) from the social network server 102a (or any of social network servers through 102n). The permission application 305 makes certain that the user device is compliant with protocols and any privacy concerns. The company information retrieval application 307 retrieves information about one or more companies that indicate employment opportunities within the social graph (e.g., friends, friends of friends, etc.). The employment search application 309 searches for employment opportunities within the companies retrieved by the company information retrieval application 307 for the particular user 125a. The employment search application 309 identifies any opportunity that is pertinent to the particular user 125a and informs the employment suggestion application 311 of those opportunities. The employment suggestion application or engine 311 receives the opportunities found by the employment search application 309 and receives the information from the employment retrieval application 303 and tailors one or more employment opportunity suggestions, based on the employment history of the particular user 125a. For example, the employment suggestion application 311 determines that the particular user 125a has computer software experience in his education and/or work history and filters the employment opportunities found, to suggest only employment opportunities relating to computer software positions.

Once the employment suggestion application 311 has isolated a sub-set of employment opportunities, it conveys them to the messaging application 311, which creates and sends messages or notifications to the user 125a.

### Methods

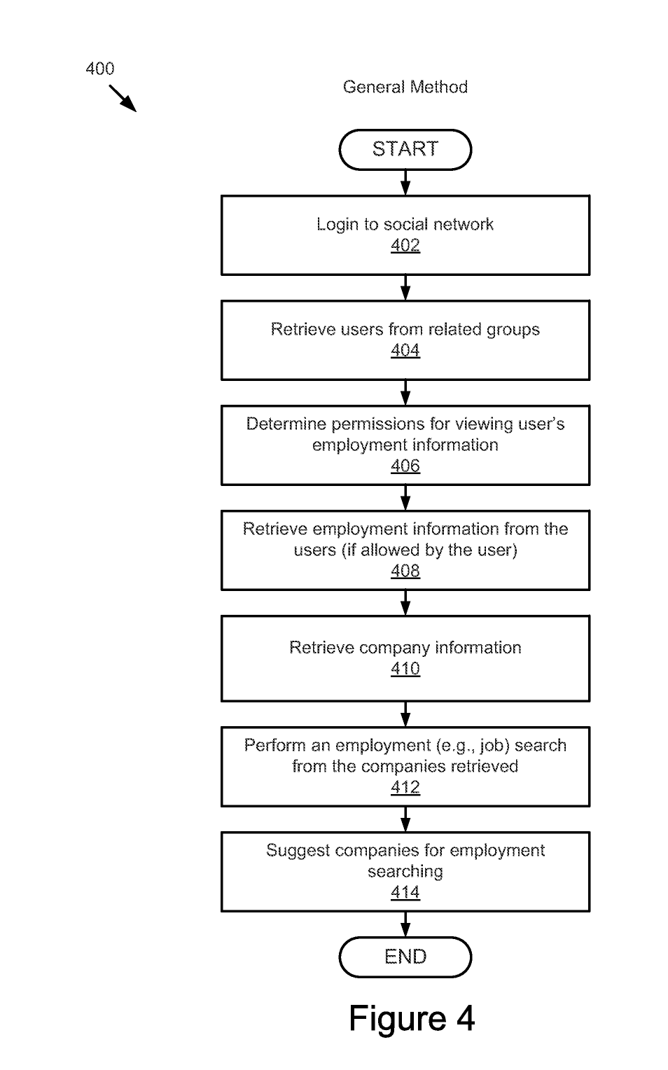

FIG. 4 is a flow chart illustrating one example of a general method 400 for providing a framework of a search engine for searching for employment opportunities within a social network. In the method illustrated, operations begin with a login to a social network, as illustrated by block 402. The method proceeds to the next block 404, at which stage, one or more users, identified as belonging to groups within the social network are retrieved from the social graph 108. For example, users are selected if they have listed their employer and/or employment description with the social network. Those users who have not indicated any employment information are clearly not selected. In some instances, users with no employment information may be approached to share their employment particulars.

The method proceeds to block 406, at which stage, the method operations (one or more) determine user permissions before retrieving user information for the one or more users identified in step 404. In some embodiments, the method operations determine permissions by analyzing user-set permission settings within a user's profile information. In yet other embodiments, user permissions may be determined based on evaluating social relationships with the users requesting information. For example, information may be retrieved from a circle of immediate friends within the social graph, to the extent users have indicated “complete” sharing within the circle. In such situations, access to information of “friends of friends” within the social graph is not made available. In yet other embodiments, the system may pose inquiries to users to seek permissions at other times.

The method proceeds to the next block 408, at which stage, the method operations retrieve employment information for the list of those users retrieved at step 404 (after obtaining permissions). For example, the method retrieves employment history for users from various sources, for example, if it posted or provided by users, or if the system 100 has permission to obtain the information for or from users. In some embodiments, the method retrieves the education history for users, which is relevant to determine user experience, employments interests etc. Any or all these factors are relevant when searching for relevant employment opportunities.

The method proceeds to the next block 410, at which stage, the method retrieves information on various companies that are identified as offering employment opportunities or that conduct business in areas of interest to a particular user's search, education, or experience. In some embodiments, this information may include 1) one or more past employment opportunities offered by the company or 2) information necessary for users to apply to the company, even if no employment opportunities are currently offered.

The method proceeds to the next block 412, at which stage, the operations of the method conduct an employment search within these companies (retrieved at step 410) for any current employment opportunities at the company. In some embodiments, the employment search isolates one or more companies that are of interest to employment search and determines the current employment listings, filtering them based on user preferences.

The method proceeds to the next block 414, at which stage, the method operations compile a list of employment opportunities for a particular user, for example, a single list, or multiple lists that may be categorized and formulated to pose suggestions to users. These suggestions may include companies pertinent to a particular user's employment search, isolated for the particular user, based on the particular user's employment history or the particular user's education or both. For example, the operations of the method suggest particular computer companies after analyzing the particular user's employment information and finding either computer related past experience or education. These suggestions may also include current employment listings at particular companies. In addition, these suggestions may also include friends or associates of the particular user at specific companies, in the event these contacts are able to assist the particular user with obtaining a position at those specific companies. Once these suggestions are generated, in some embodiments, the operations of the method send one or more notifications to the particular user with the one or more employment descriptions or lists.

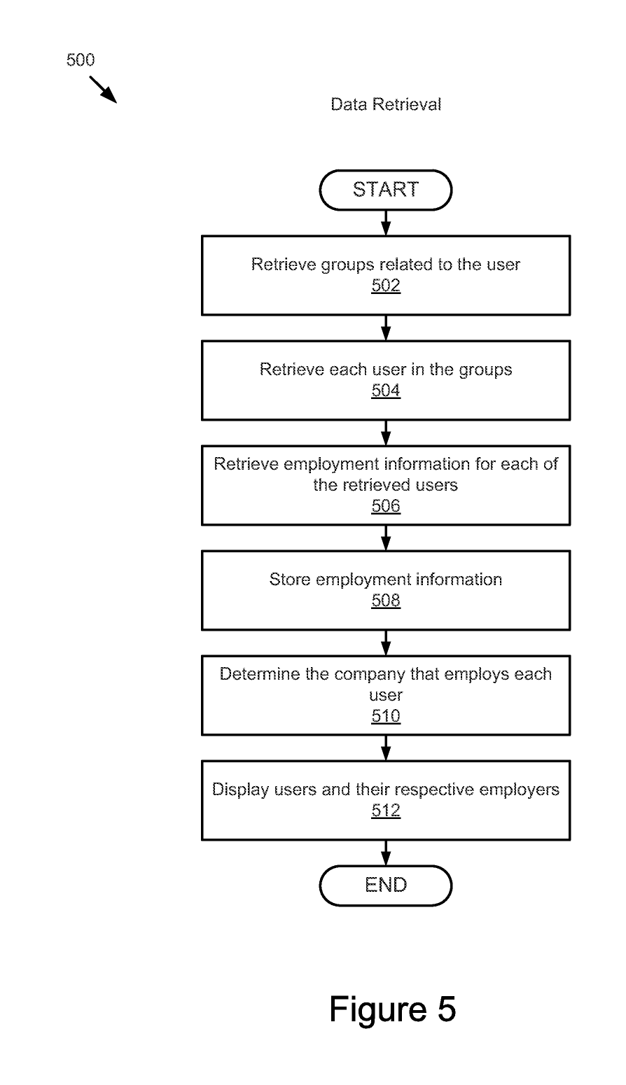

FIG. 5 is a flow chart illustrating one example of a method and its operations, indicated generally by reference numeral 500. The operations of this example method are for retrieving data that is pertinent to employment from within a particular user's social graph in order to gather and create information that is relevant to employment. The method illustrated begins with retrieving groups of users (e.g., social circles) from a social graph 108, as indicated by block 502.

The method proceeds to the next block 504, at which stage, the operations of the method retrieve the identity of each user in the groups (i.e., from the social graph 108). For example, user identities are retrieved (after obtaining permission) from within the user's friends, friends of friends, etc.

The method proceeds to the next block 506, at which stage, the method retrieves the employment information for each of the users retrieved in step 504. For example, information on the employment history for a particular user (the one or more companies the user was employed with), employment or job titles that the particular held, schools the particular user attended, the degrees the particular user was awarded, etc.

The method proceeds to the next block 508, at which stage, the method stores the employment information gathered in the data storage 233, for example as user data 250.

The method proceeds to the next block 510, at which stage, the one or more operations of the method determine the one or more companies that have either employed users (within the groups) or currently employ them.

The method proceeds to the next block 512, at which stage, the one or more operations of the method display the users and the employers that employ the users. The method may simply display either the users or the employers.

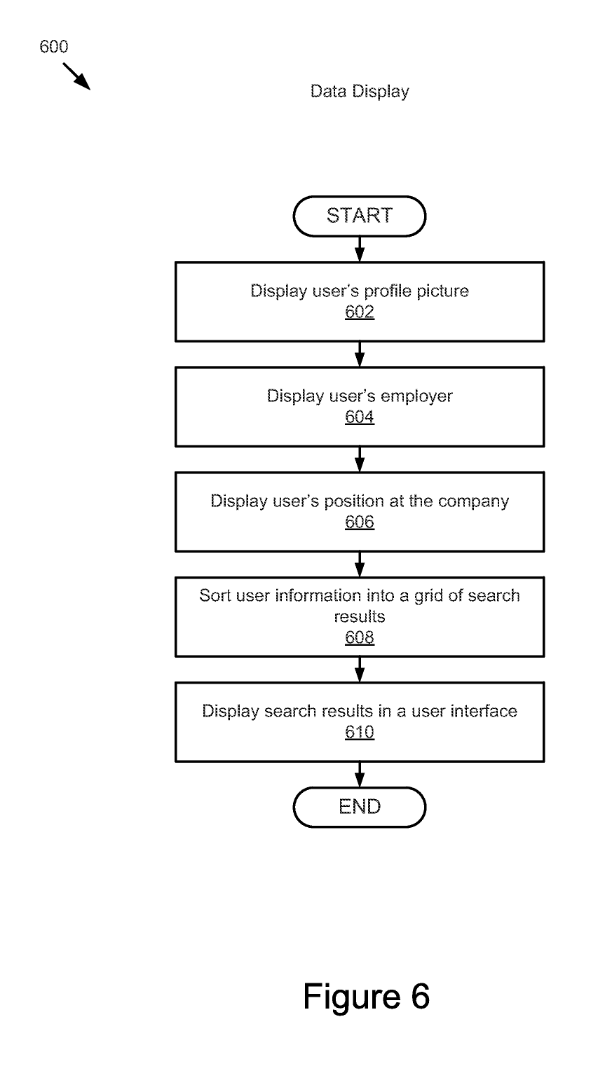

FIG. 6 is a flow chart illustrating one example of a method indicated generally by reference numeral 600 for displaying data that is pertinent to employment information of users connected by a social graph 108. The method illustrated begins with displaying user profile pictures of users connected by the social graph 108, as illustrated by block 602.

The method proceeds to the next block 604, at which stage, the method displays employers that employ the users who are connected by the social graph 108. The method may display past and present employers with appropriate indications that illustrate employer status.

The method proceeds to the next block 606, at which stage, the method displays a particular user's employment title (e.g., President, Vice-President, Project Engineer etc.) at the company or status (e.g., Shareholder, Partner, full-time employee, part-time employee etc.) with the company.

The method proceeds to the next block 608, at which stage, the method sorts user information into a grid and lists the search results. Alternatively, the method may simply present the information in any other format.

The method proceeds to the next block 610, at which stage, the method displays the grid and the list of search results to users via a user interface. The user interface is described in greater detail with reference to FIGS. 7-9.

### Graphical User Interface

Referring now to FIG. 7, some embodiments of a user interface are illustrated. For example, user interface 700 illustrates a profile for an example user, Bob XYZ, indicated by reference numeral 702. This user interface 700 is indicated as displayed on any one or more of user devices 115a through 115n. The user interface 700 provides or displays a listing of companies (for example, company A through L) indicated by reference numeral 740. These companies employ one or more users who are within the social graph 108 of the particular user, Bob XYZ (702). In the present example illustrated, a curser 720 is used to select a company, and a floating button 710 appears on the screen. The button 710, when selected, lists one or more users in the user's (e.g., Bob XYZ) social graph 108 who are employed at the selected company (e.g., company A). In some embodiments, a button 730 is displayed, which when selected, displays more companies of interest from the user's social graph 108. To manage the number of results displayed to a user, the results may be displayed in segments, first, a predefined number, followed by a next predefined number and so on. The predefined number may be the same or different.

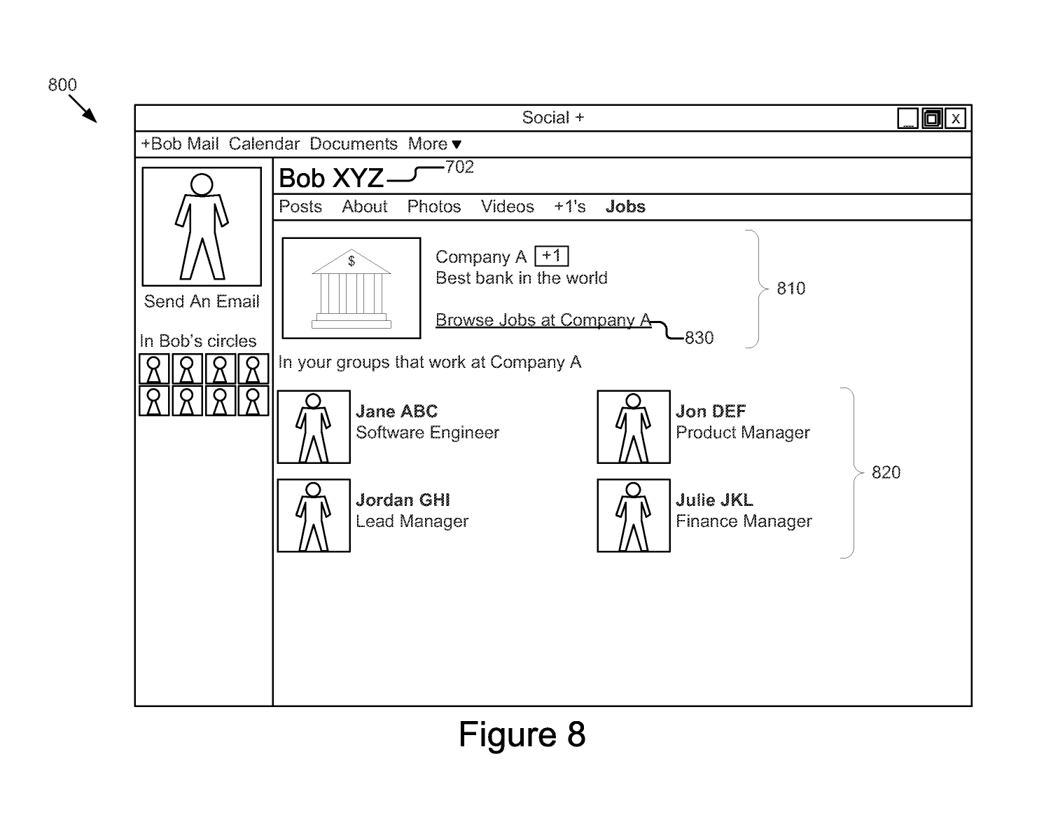

Referring now to FIG. 8, Company A and information on it, indicated by reference numeral 810, are displayed to the user via the user interface. This display occurs when a user selects a particular company of interest, in this case, example Company A. In some embodiments a list of users, for example, “Jane ABC,” “Jordan GHI,” “Jon DEF,” and “Julie JKL”, indicated by reference numeral 820, all of whom are employed by Company A are displayed to the user. In this example, “Jane ABC” is the software engineer for Company A, “Jon DEF” is the product manager at Company A, “Jordan GHI” is the lead manager at Company A, and “Julie JKL” is the finance manager at Company A. In some embodiments a user may select one or more users who are employed at Company A in order to view their user profiles. In other embodiments, a user may select a link 830 to browse one or more employment listings or jobs at Company A. Company A serves as the filter to present only employment positions from that company to the user.

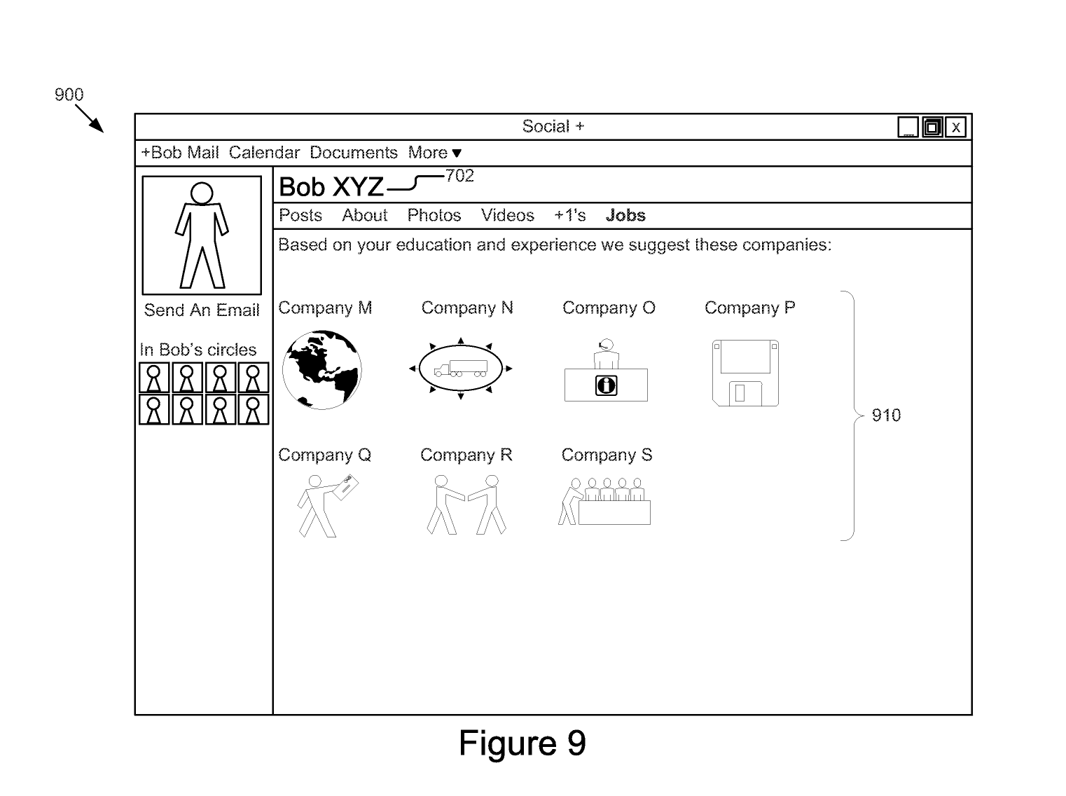

Referring now to FIG. 9, a list of one or more companies indicated by reference numeral 910 are displayed in another example of a social network user interface 900. The companies 910 are selected based on the user's (Bob XYZ 702) employment or education history or both. For example, the user's (Bob XYZ 702) employment or education history or both include both customer service and computer programming experience or interests and the companies 902 displayed offer a combination of both customer service employment positions as well as computer programming positions.

The foregoing description of the embodiments of the present technology has been presented for the purposes of illustration and description. It is not intended to be exhaustive or to limit the present technology to the precise form disclosed. Many modifications and variations are possible in light of the above teaching. It is intended that the scope of the present technology be limited not by this detailed description, but rather by the claims of this application. As should be understood by those familiar with the art, the present technology may be embodied in other specific forms, without departing from the spirit or essential characteristics thereof. Likewise, the particular naming and division of the modules, routines, features, attributes, methodologies, and other aspects are not mandatory or significant, and the mechanisms that implement the present disclosure or its features may have different names, divisions and/or formats. Furthermore, as should be apparent to one of ordinary skill in the relevant art, the modules, routines, features, attributes, methodologies and other aspects of the present technology can be implemented as software, hardware, firmware, or any combination of the three. Also, wherever a component, an example of which is a module, of the present technology is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present technology is in no way limited to implementation in any specific programming language, or for any specific operating system or environment. Accordingly, the disclosure of the present technology is intended to be illustrative, but not limiting, of the scope of the present disclosure, which is set forth in the following claims.

1. A computer-implemented method for identifying and suggesting employment opportunities based on connections in a social network, executing on one or more computing devices, the method comprising:
receiving, using the one or more computing devices, a request from a first user of a social network to identify and provide one or more employer entities with employment opportunities for the first user based at least in part on the first user's social graph, the first user being associated with a first user profile in the social network;
retrieving, by at least one of the one or more computing devices, the social graph for the first user, the social graph defining online connections established by the first user with one or more other users on the social network with whom the first user shares an affinity;
retrieving, by at least one of the one or more computing devices, one or more user profiles from the social network of connected users in accordance with the social graph of the first user, the one or more user profiles having a connection to the first user profile in the social network, and the one or more user profiles indicating a designation for complete sharing of information;
identifying, by at least one of the one or more computing devices, the one or more employer entities of record for connected users in the social network, based at least in part, on determining an affiliation between the one or more user profiles and the one or more employer entities of record in the social network, the affiliation indicating previous and current employment of users by the employer entities of record that are identified;
searching, by at least one of the one or more computing devices, for one or more employment opportunity descriptions currently offered by the one or more employer entities of record within the social network based on a preference and employment history of the first user; and
providing for display, by at least one of the one or more computing devices, suggestions for the first user indicating the one or more employer entities of record including the one or more employment opportunity descriptions offered by the one or more employer entities, the suggestions indicating the one or more employer entities also includes an indication specifying which of the one or more other users on the social network with whom the first user shares an affinity are employed at the one or more employer entities.

2. A computer-implemented method according to claim 1, further comprising:
suggesting, using the one or more computing devices, the one or more employer entities of record, based at least in part on, profile information for the first user.

3. A computer-implemented method according to claim 1, further comprising:
sending, using the one or more computing devices, one or more notifications relating to the one or more employment opportunity descriptions to the first user, the one or more employment opportunity descriptions being offered by the one or more employer entities that are identified, based at least in part on, determining an affiliation between the one or more user profiles that have a connection to the first user profile and the one or more employer entities of record in the social network.

4. A computer-implemented method according to claim 1, further comprising:
determining, using the one or more computing devices, whether the first user has permission for the first user to view the one or more employment opportunity descriptions before providing for display the one or more employment opportunity descriptions.

5. A computer-implemented method according to claim 1, further comprising:
providing for display search results relating to the one or more employer entities, including at least one of a profile picture associated with a second user profile of the one or more user profiles connected to the first user profile in the social network, wherein the second user profile is associated with the one or more employer entities.

6. A computer-implemented method according to claim 1, further comprising:
initiating an employment search wherein the one or more employer entities serve as a filter.

7. A computer-implemented method according to claim 1, wherein identifying the one or more employer entities of record for connected users in the social network comprises:
providing for display, using the one or more computing devices, a selection of two or more employer entities of record in the social network, the two or more employer entities of record in the social network having been selected, based at least in part on, affiliations between the one or more user profiles and the two or more employer entities of record in the social network; and
receiving, using the one or more computing devices, a selection of the one or more employer entities of record in the social network.

8. A computer-implemented method according to claim 7, further comprising:
using the at least one employer entity selected by the user as a filter to obtain employment opportunity descriptions only from the at least one employer entity selected.

9. A computer-implemented method according to claim 7, further comprising:
using the at least one employer entity selected by the user as a filter to obtain a list of other users employed by the employer entity selected.

10. A system for identifying and suggesting employment opportunities based on user connections in a social network, the system comprising:
one or more processors, the processor configured to provide:
a user interface input configured to receive a request from a first user of the social network to identify and provide one or more employer entities with employment opportunities for the first user based at least in part on the first user's social graph, the first user being associated with a first user profile in the social network;
a company suggestion module configured to retrieve a social graph for the first user, the social graph defining online connections established by the first user with one or more other users on the social network with whom the first user shares an affinity, to retrieve one or more user profiles from the social network in accordance with the social graph of the first user, the one or more user profiles having a connection to the first user profile in the social network and the one or more user profiles indicate a designation of complete sharing of information, to identify one or more employer entities of record for connected users in the social network, based at least in part, on an affiliation between the one or more user profiles and the one or more employer entities of record in the social network, the affiliation indicating previous and current employment of users by the employer entities of record that are identified, and to search for one or more employment opportunity descriptions currently offered by the one or more employer entities of record within the social network based on a preference and employment history of the first user; and
user interface output configured to provide for display suggestions for the first user indicating the one or more employer entities of record including the one or more employment opportunity descriptions offered by the one or more employer entities, the suggestions indicating the one or more employer entities also includes an indication specifying which of the one or more other users on the social network with whom the first user shares an affinity are employed at the one or more employer entities.

11. A system according to claim 10, wherein the company suggestion module suggests the one or more employer entities, based at least in part on, profile information for the first user.

12. A system according to claim 10, wherein the user interface output is configured to send one or more notification on the one or more employment opportunity descriptions to the first user, the one or more employment opportunity descriptions being offered by the one or more employer entities that are identified, based at least in part on, determining an affiliation between the one or more user profiles that have a connection to the first user profile and the one or more employer entities of record in the social network.

13. A system according to claim 10, wherein the company suggestion module is configured to determine permission for the first user to view the one or more employment opportunity descriptions before providing for display the one or more employment opportunity descriptions.

14. A system according to claim 10, wherein the company suggestion module is coupled to the user interface output, to provide for display, a selection of two or more employer entities of record in the social network, the two or more employer entities of record in the social network having been selected, based at least in part on, affiliations between the one or more user profiles and the two or more employer entities of record in the social network.

15. A system according to claim 14, wherein the company suggestion module further comprises:
a filter for conducting an employment search including at least in part the two or more employer entities selected.

16. A computer program product for identifying and suggesting employment opportunities based on connections in a social network, comprising a non-transitory computer useable medium including a computer readable program, wherein the computer readable program when executed on a computer causes the computer to:
receive a request from a first user of a social network to identify and provide one or more employer entities with employment opportunities for the first user based at least in part on the first user's social graph, the first user being associated with a first user profile in the social network;
retrieve a social graph for the first user, the social graph defining online connections established by the first user with one or more other users on the social network with whom the first user shares an affinity;
retrieve one or more user profiles from the social network of connected users in accordance with the social graph of the first user, the one or more user profiles having a connection to the first user profile in the social network, and the one or more user profiles indicating a designation for complete sharing of information;
identify one or more employer entities of record for connected users in the social network, based at least in part, on determining an affiliation between the one or more user profiles and the one or more employer entities of record in the social network, the affiliation indicating previous and current employment of users by the employer entities of record that are identified;
search for one or more employment opportunity descriptions currently offered by the one or more employer entities of record within the social network based on a preference and employment history of the first user; and
provide for display suggestions for the first user indicating the one or more employer entities of record including the one or more employment opportunity descriptions offered by the one or more employer entities, the suggestions indicating the one or more employer entities also includes an indication specifying which of the one or more other users on the social network with whom the first user shares an affinity are employed at the one or more employer entities.

17. A computer program product according to claim 16, wherein the computer readable program when executed on a computer further causes the computer to:
suggest the one or more employer entities of record, based at least in part on, profile information for the first user.

18. A computer program product according to claim 16, wherein the computer readable program when executed on a computer further causes the computer to:
send one or more notifications relating to the one or more employment opportunity descriptions to the first user, the one or more employment opportunity descriptions being offered by the one or more employer entities that are identified, based at least in part on, determining an affiliation between the one or more user profiles that have a connection to the first user profile and the one or more employer entities of record in the social network.

19. A computer program product according to claim 16, wherein the computer readable program when executed on a computer further causes the computer to:
determine whether the first user has permission for the first user to view the one or more employment opportunity descriptions before providing for display the one or more employment opportunity descriptions.

20. A computer program product according to claim 16, wherein the computer readable program when executed on a computer further causes the computer to:
provide for display search results relating to the one or more employer entities, including at least one of a profile picture associated with a second user profile of the one or more user profiles connected to the first user profile in the social network, wherein the second user profile is associated with the one or more employer entities.

21. A computer program product according to claim 16, wherein the computer readable program when executed on a computer further causes the computer to:
initiate an employment search wherein the one or more employer entities serve as a filter.

22. A computer program product according to claim 16, wherein the computer readable program when executed on a computer further causes the computer to:
provide for display a selection of two or more employer entities of record in the social network, the two or more employer entities of record in the social network having been selected, based at least in part on, affiliations between the one or more user profiles and the two or more employer entities of record in the social network; and
receive a selection of the one or more employer entities of record in the social network.

23. A computer program product according to claim 22, wherein the computer readable program when executed on a computer further causes the computer to:
use the at least one employer entity selected by the user as a filter to obtain employment opportunity descriptions only from the at least one employer entity selected.

24. A computer program product according to claim 22, wherein the computer readable program when executed on a computer further causes the computer to:
use the at least one employer entity selected by the user as a filter to obtain a list of other users employed by the employer entity selected.
